(19) United States
(12) Patent Application Publication
(10) Pub. No.: US 2009/0001262 A1
(43) Pub. Date: Jan. 1, 2009

(54) System and Method for Spectral Analysis

(76) Inventors: Erik Visser, San Diego, CA (US); Tzyy-Ping Jung, San Diego, CA (US); Kwokleung Chan, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/659,629

(22) PCT Filed: Oct. 22, 2004
(86) PCT No.: PCT/US2004/035724

§ 371 Date: Feb. 7, 2007

Related U.S. Application Data
(60) Provisional application No. 60/513,404, filed on Oct. 22, 2003.

(51) Int. Cl. H01J 49/26

(52) U.S. Cl. 250/282; 250/281

(57) ABSTRACT

The system and method for spectral analysis uses a set of spectral data. The spectral data is arranged according to a second dimension, such as time, temperature, position, or other condition. The arranged spectral data is used in a signal separation process, such as an independent component analysis (ICA), which generates independent signals. The independent signals are then used for identifying or quantifying a target component.

### FIELD OF THE INVENTION

The present invention relates to blind source separation and classification of spectroscopic data. More specifically it relates to the blind source separation of multi-dimensional spectroscopic data.

### BACKGROUND OF THE INVENTION

Spectroscopic data are usually acquired in the form of a spectrum. A spectrum can be used to obtain information about physical, biological or chemical elements, such as atomic and molecular energy levels, molecular geometries, chemical bonds/compositions/structure, interactions of molecules, density, pressure, temperature, magnetic fields, velocity, and related characteristics and processes. Often, spectra are used to identify the components of a sample (qualitative analysis). Spectra may also be used to measure the amount of material in a sample (quantitative analysis). Although the spectrum is often scaled to the intensity of energy detected, frequency or wavelength, other scales or measures may be used such as the mass or momentum of the energy. The collection and analysis of a spectrum usually involves: a source of light or other electromagnetic radiation (an energy source such as a laser, ion source or radiation source) and a device for measuring the change in the energy source after it has interacted with a sample (often a spectrophotometer or interferometer). There are as many different types of spectroscopy as there are energy sources, for example astronomical spectroscopy, atomic absorption spectroscopy, attenuated total reflectance spectroscopy, electron paramagnetic spectroscopy, electron spectroscopy, Fourier transform spectroscopy, gamma-ray spectroscopy, infrared spectroscopy, laser spectroscopy (e.g., absorption spectroscopy, fluorescence spectroscopy, Raman spectroscopy, and surface-enhanced Raman spectroscopy), mass spectrometry, multiplex or frequency-modulated spectroscopy and x-ray spectroscopy. The term spectrometry is usually used instead of spectroscopy when the intensities of the signals at different wavelengths are measured electronically, although they are interchangeably employed herein.

Spectra can be obtained either in the form of emission spectra, which show one or more bright lines or bands against a dark background, or absorbance spectra, which have a continually bright background and depict the spectral information as one or more dark lines. See, generally, Gauglitz and Vo-Dinh, Handbook of Spectroscopy, Wiley-VCH; (October 2003), and Jansson, P. A., Deconvolution of Images and Spectra Academic Press; 1st edition (Jan. 15, 1997). Absorbance spectroscopy measures the loss of electromagnetic energy after the energy interacts with the sample under study. For example, if a light beam containing a broad mixture of wavelengths is directed at a vapor of atoms, ions, or molecules, the particles will absorb those wavelengths that can excite them from one quantum state to another. Consequently, the absorbed wavelengths will be missing from the original light mixture (spectrum) after it has passed through the sample. Because most atoms and many molecules have unique and identifiable energy levels, a measurement of the missing (absorbance) lines enables identification of the absorbing species. Absorbance within a continuous band of wavelengths is also possible. This type of absorbance is particularly common when there is a large population of absorbance lines that have been broadened by strong perturbations from surrounding atoms (e.g., collisions in a high-pressure gas, or interactions with nearby neighbors in a solid or liquid).

An invaluable tool in organic structure determination and verification involves the class of electromagnetic radiation with frequencies between 4000 and 400 cm⁻¹. This category of radiation is termed infrared (IR) radiation, and its application to organic chemistry known as IR spectroscopy. Radiation in this region can be utilized in organic structure determination by making use of the fact that it is absorbed by inter-atomic bonds in organic compounds. Chemical bonds in different environments will absorb varying intensities and at varying frequencies. The frequencies at which there are absorptions of IR radiation (“peaks” or “signals”) can be correlated directly to bonds within the compound in question. Because each inter-atomic bond may vibrate in several different motions (stretching or bending), individual bonds may absorb at more than one IR frequency. Stretching absorptions usually produce stronger peaks than bending, however the weaker bending absorptions can be useful in differentiating similar types of bonds

The standard model used to relate measured IR absorbance data to the concentration profiles of absorbing species and their pure component IR spectra is the linear Beer-Lambert law (or Beer's law). This model plays a central role in chemometrics, the discipline concerned with characterizing (bio)chemical reaction systems from absorbance data acquired by measuring infrared absorption of chemical reaction components mixed at certain concentrations, each of them presenting a “fingerprint” pure component spectrum. A range of experimental conditions like pressure, concentration and temperature can be given for which this model is considered valid. In chemometrics determining component spectra and concentrations using various degrees of a priori knowledge is commonly referred to as “black” (no a priori knowledge) and “grey” (some a priori knowledge) modeling (Liang, Kvalheim, Manne, White, Grey and Black Multi-Component Systems, Chemometrics and Intelligent Laboratory Systems, 1993). While a number of approaches have been investigated in the literature, a popular approach in “black” modeling consists of minimizing a second order derivative entropy term subject to constraints to resolve the pure component spectra in combination with a PCA decomposition (Sasaki, K., Kawata, S., Minami, S., Estimation of Component Spectral Curves From Unknown Mixture Spectra, 1984). However these techniques suffer from the assumption of orthogonal, spectrally “non-overlapping” pure component spectra and poor convergence properties in the absence of a priori information about the absorbing species involved. A statistical technique is thus needed providing blind separation of “black’ component systems i.e. without requiring any a priori information about the reaction components involved.

Another spectroscopic application area of the proposed method is Magnetic Resonance Spectroscopy (MRS). MRS experiments involve the radiative transitions between two magnetic energy levels of a molecule or radical in the presence of an applied laboratory magnetic field (Matson, G. B., Weiner, M. W. (2003): Spectroscopy. Chapter in Magnetic Resonance Imaging). Similarly, in order for a radiative transition to be possible between two magnetic levels or states, the states must possess a magnetic energy difference ΔEmag. In order for a radiative transition between two magnetic states to be plausible, the two states must differ in some feature of their magnetic moments so that the oscillating magnetic field of the electromagnetic field of light can interact with the magnetic moments and drive them into oscillation. For the latter to happen, the frequency of the oscillating magnetic field, ν, must be such that ΔEmag=hv. Since the transitions occur only at the frequency ν (RF range), the phenomenon is termed magnetic resonance and the technique magnetic resonance spectroscopy. The magnetic moments of electrons and nuclei of molecules can take definite orientations in space because of the effect of an externally applied magnetic field in a laboratory setting. The nuclei constituting the molecule on the other hand also generate an internal field acting as a shield and leading to a so called chemical shift which causes nuclear spins in different chemical environments to undergo resonance at different frequencies (in the presence of a fixed value of an applied laboratory field). The immediate chemical neighborhood of a nucleus generates the fine and hyper-fine structure of chemical shifts (singlets, duplets, multiplets) in MR spectra and allows the researcher to identify distinct molecules having similar atomic composition but different spatial structure.

The vast majority of magnetic resonance imaging is mainly focused on the study of the resonance properties of 1H, a nucleus present in many organic molecules and therefore particularly suited for the study of human or animal tissue. In vivo magnetic resonance spectroscopy (MRS) began with analysis of isolated tissues or surface regions from intact animals, before the availability of gradients for MRI led to the development of localization techniques that obtain spectra from single volumes of tissue. These single volume techniques are used today for 1H, 31P, 13C, 19F and other nuclei. Metabolic imaging is possible using Magnetic Resonance Spectroscopic Imaging (MRSI), which uses phase encoding to obtain spectra from multiple regions across a field of view.

There is considerable information in the in vivo 1H NMR spectrum that is currently only poorly utilized, or requires specialized measurements to obtain. Frequently, metabolite signals are hidden under much stronger lipid or water resonances. Several metabolites are present at relatively high concentrations, though the MR sensitivity for their detection is poor due to their signal energy being spread over a large number of closely spaced multiplet resonances; strong overlapping resonances due to phase differences in spin echo sequences such as glutamate, glutamine and GABA with 1H MRSI (Mason et al. 1994); finally inadequate water suppression and distorted spectral lineshapes. Short acquisition times and use of spectral analysis programs which look for all multiplet resonances will improve detection of coupled spin systems. Although these methods tend to optimize observation of one metabolite, they may be tailored to specific clinical applications. The problem of spectral overlap can also be addressed by performing 2D MR experiments (i.e. 2 spectral dimensions). The obvious disadvantage of these techniques is that multiple measurements must be taken to obtain the two-dimensional NMR data, and for this reason the current in vivo 2D studies have been limited to single volume measurements.

Further development of advanced signal processing methods offers the potential for significant improvement in both spatial and spectral information (Liang, Boada, Constable, Haacke, Lauterbur, Smith. Constrained reconstruction methods in MR imaging. (1992); Miller, Schaewe, Bosch, Ackerman. Model based maximum-likelihood estimation for phase and frequency encoded magnetic resonance imaging data. (1995); Plevritis, Macovski. MRS imaging using anatomically based k-space sampling and extrapolation. (1995)). In the spatial dimensions, the challenge is to obtain higher resolution information given a truncated sampling of the data (k-space). Limitations of Fourier methods are well known, which results in ringing from the edges of an object. While smoothing the data can reduce this ringing, this comes at the expense of spatial resolution. Other signal processing methods have been applied to spectral data to uncover the underlying pure component spectra from a multi-dimensional measurement matrix by applying PCA (Stoyanova, Kuesel, Brown, Application of Principal Component Analysis for NMR Spectral Quantitation, Journal of Magnetic Resonance, 1995) or maximum likelihood techniques under positivity constraints (Sajda, Du, Brown, Parra, Stoyanova, Recovery of Constituent Spectra in 3D Chemical Shift Imaging using Non-Negative Matrix Factorization, Proceedings of ICA 2003, 2003). However a statistical signal processing technique is needed that achieves greater detection sensitivity and increased chemical shift dispersion without imposing orthogonal pure component spectra (PCA) and requiring only a minimum amount of a priori knowledge.

Blind Source Separation or, equivalently, Independent Component Analysis (ICA) are techniques for separating mixed source signals (components) which are presumably independent from each other. In its simplified form, independent component analysis operates an “un-mixing” matrix of weights on the mixed signals, for example multiplying the matrix with the mixed signals, to produce separated signals. The weights are assigned initial values, and then adjusted to minimize mutual information among the output signals. This weight-adjusting process is repeated until the joint information redundancy of the measured signals is reduced to a minimum. Because this technique does not require a priori information on the source of each signal, it is known as a “blind source separation” method. Blind separation problems refer to the idea of separating mixed signals that come from multiple independent sources.

Although there are many ICA or BSS techniques currently known, many have evolved from the works by Comon (1994) and Bell and Sejnowski (1995) described in U.S. Pat. No. 5,706,402 issued to Bell. There are now many different ICA or BSS techniques or algorithms, including some of the better known algorithms such as JADE (Cardoso & Souloumiac (1993) IEE proceedings-F, 140(6); SOBI (Belouchrani et al. (1997) IEEE transactions on signal processing 45(2)); BLISS (Clarke, I. J. (1998) EUSIPCO 1998)); Fast ICA (Hyvarinen & Oja (1997) Neural Compuation 9:1483-92); and the like. A summary of the most widely used algorithms and techniques can be found in books and references therein about ICA and BSS (e.g Baxter et al., WO 03/073612; Te-Won Lee, Independent Component Analysis: Theory and Applications, Kluwer Academic Publishers, Boston, September 1998, Hyvarinen et al., Independent Component Analysis, 1st edition (Wiley-Interscience, May 2001); Haykin, Simon. Unsupervised Adaptive Filtering, Volume 1: Blind Source Separation. Wiley-Interscience; (Mar. 31, 2000); Haykin, Simon. Unsupervised Adaptive Filtering Volume 2: Blind Deconvolution. Wiley-Interscience (February 2000); Mark Girolami, Self-Organizing Neural Networks: Independent Component Analysis and Blind Source Separation (Perspectives in Neural Computing) (Springer Verlag, September 1999); and Mark Girolami (Editor), Advances in Independent Component Analysis (Perspectives in Neural Computing) (Springer Verlag August 2000). Singular value decomposition algorithms have been disclosed in Adaptive Filter Theory by Simon Haykin (Third Edition, Prentice-Hall (NJ), (1996).

Many popular ICA and BSS algorithms have been developed to optimize their performance, including a number which have evolved by significant modifications of those which only existed a decade ago. For example, the work described in A. J. Bell and T J Sejnowski, Neural Computation 7:1129-1159 (1995), and Bell, A. J. U.S. Pat. No. 5,706,402, is usually not used in its patented form. Instead, in order to optimize its performance, this algorithm has gone through several recharacterizations by a number of different entities. One such change includes the use of the “natural gradient”, described in Amari, Cichocki, Yang (1996). Other popular ICA algorithms include methods that compute higher-order statistics such as cumulants (Cardoso, 1992; Comon, 1994; Hyvaerinen and Oja, 1997). The common characteristic of all ICA algorithms is that they make use of an objective function or contrast function that is related to measuring the mutual information among signals and they use an optimization algorithm to find a linear unmixing system.

### SUMMARY OF THE INVENTION

The present invention relates to the blind source separation of spectroscopic data. More particularly, the present invention relates to systems and methods which perform blind source separation of spectroscopic data for spectral separation. The system or method collects data from monitoring several spectrally-distinguishable components and creates a data matrix from the collected data which, in addition to its spectral dimension, has additional dimensions, such as time, energy, spatial dimension and/or conditional factors. This multi-dimensional data matrix is then processed by a suitably designed ICA algorithm separating the mixed component spectra. The separated signals may then be useful for detecting, locating, or quantifying a target component.

Since statistical independence is the only assumption made about the underlying component spectra, the resolution of the latter spectra is not constrained by artificial orthogonality assumptions and not limited to scenarios where a priori information about source components is available. However, in some instances, a priori information may be useful to more efficiently process the spectral datasets, and also may be useful in identifying a target component.

Yet another aspect of the invention are systems and methods for establishing a relationship between spectral data and a biological, chemical, or physical property, by analyzing the spectral data and detecting patterns in the spectral data that are associated with the property. Knowledge of the structural features that lead to the spectral data is not needed beforehand. By separating highly overlapping recorded mixture spectra into underlying independent component spectra, new dynamic and structural information about processes relevant to chemical, biochemical and medical applications is thereby made available for monitoring and explorative purposes.

In particular, the invention systems and processes are applicable to a number of different endeavors, such as laboratory research and investigations, microscopic imaging, infrared, near-infrared, visible absorption, Raman and fluorescence spectroscopy and imaging, satellite imaging, quality control, industrial process monitoring, combinatorial chemistry, genomics, biological imaging, pathology, drug discovery, threat detection, and pharmaceutical formulation, testing, counterfeit detection, satellite imaging and detection of defects in industrial processes. Generally, the invention can be applied to spectrometers which detect radiation from a sample and process the resulting signal to obtain and present an image or spectrum of the sample that includes spectral and chemical, biological or physical information about the sample.

The spectral data may be just one type of spectral data (such as nuclear magnetic resonance spectroscopic (NMR) data, for example “C-NMR), or more than one type of spectral data (such as a composite of two or more types of spectral data), such spectral data including without limitation NMR, mass spectral, infrared (IR), magnetic resonance spectroscopy (MRS) ultraviolet-visible (UV-Vis), fluorescence, or phosphorescence data, or variations thereof including far and near spectral data. Such spectral data can be acquired via astronomical spectroscopy, atomic absorption spectroscopy, attenuated total reflectance spectroscopy, electron paramagnetic spectroscopy, electron spectroscopy, fourier transform spectroscopy, gamma-ray spectroscopy, infrared spectroscopy, laser spectroscopy (e.g., absorption spectroscopy, fluorescence spectroscopy, Raman spectroscopy, and surface-enhanced Raman spectroscopy), mass spectrometry, multiplex or frequency-modulated spectroscopy and x-ray spectroscopy.

In the following, the InfraRed (IR) and Magnetic Resonance (MR) spectroscopic disciplines are given as exemplary models and related data processing discussed in the light of the proposed blind source separation methodology, although other examples are provided in the Examples and Drawings.

In IR applications, ICA processing of an absorbance matrix constituted by spectra recorded from a particular reaction system over a determined absorption frequency range during a certain time period yields for example information about the pure component spectra and the dynamic change in concentrations of those absorbing components during the recording period. This is achieved despite strongly overlapping and therefore non- orthogonal absorption bands of individual component spectra. Moreover, since no a priori information is required, pure component spectra of species can be resolved which have not been documented before i.e. unknown to a particular database.

In MRS applications, ICA decomposition of a two dimensional MRS data matrix with resonance spectra recorded over a spatial range for example may yield information about the spatial distribution of individual molecular entities in the analyzed sample. This is achieved with both high frequency and spatial resolution without introducing ringing or distortion artifacts commonly observed with conventional Fourier based techniques. Also solutions are not limited to orthogonal spin echo spectra and the interpretation or deconvolution of overlapping resonance phenomena is not biased towards the experimenter's a priori assumptions about constituent components. ICA will thus allow greater detection sensitivity and increased chemical shift dispersion necessary for the identification of low concentrated components and their dynamics.

In yet another embodiment, the present invention relates to an apparatus including an electromagnetic radiation separator, a spectral array detector, and a processor. The electromagnetic radiation separator spatially separates wavelengths representing multiple spectrally distinguishable molecular species. The spectral array detector generates data relating to intensity as a function of the wavelengths separated. The processor collects the data from the spectral array detector and creates a data matrix from the collected data, each element in the data matrix representing a signal intensity at a particular time, over a particular range of wavelengths or an approximated time-derivative of the signal intensity.

### BRIEF DESCRIPTION OF THE DRAWINGS

FIG. 1 is an illustration of the ICA signal processing scheme in the preferred embodiment.

FIG. 1A is a block diagram of a spectroscopic instrument in accordance with the present invention.

FIGS. 2A and 2B are flowcharts of methods for spectral analysis in accordance with the present invention.

FIG. 3 depicts graphs of the IR pure component spectra, mixture spectra and resolved ICA component spectra in a chemical reaction example with corresponding absorbing species time concentration profiles.

FIG. 4 illustrates an example of mixture MRS spectrum and separated component spectra.

FIG. 5 illustrates the spectra of resolved independent components (different components may be plotted in different color).

FIG. 6 provides the component maps which show the spatial distributions of the independent components #1 and #20.

FIGS. 7A, 7B, and 7C illustrate an example of using SERS spectral data for identifying MTBE.

FIGS. 8A, 8B, and 8C illustrate an example of using SERS spectral data for identifying another compound.

FIG. 9 illustrates an example of using spectral data for identifying a chemical or biological threat.

FIG. 10 illustrates using an identification process on a sub-band of a spectrum.

### DESCRIPTION OF THE PREFERRED EMBODIMENTS

### General Description

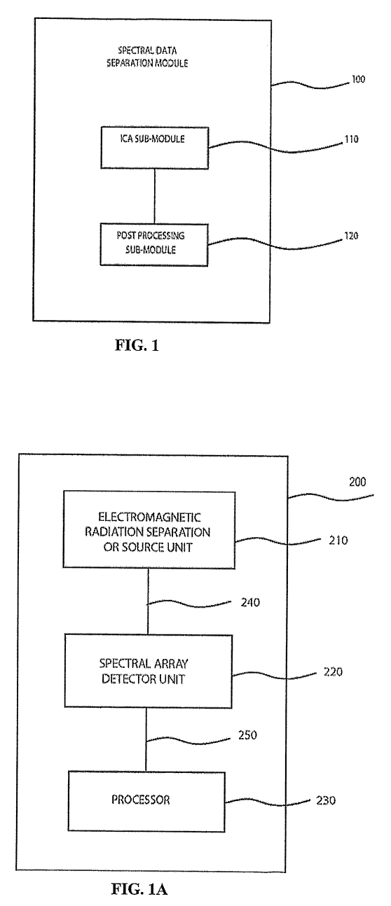

FIG. 1 illustrates one embodiment of the present invention as spectral analysis module 100. The spectral analysis module includes an ICA processing sub-module 110 and optionally a post-processing sub-module 120. This spectral analysis module 100 can be used alone (e.g., a toolbox) or in a system, as described further herein.

As used herein, a “module” or “sub-module” can refer to any apparatus, device, unit or computer-readable data storage medium that includes computer instructions in software, hardware or firmware form, or a combination thereof and utilized in systems, subsystems, components or sub-components thereof. It is to be understood that multiple modules or systems can be combined into one module or system and one module or system can be separated into multiple modules or systems to perform the same function(s). Preferably, the invention can be implemented in a variety of computing systems, environments, and/or configurations, including personal or multipurpose computer systems, hand-held or laptop devices, multiprocessor or microprocessor systems, consumer or provider electronics (including service, medical, professional, industrial, military, government, and the like), appliances, spectrometers, and other component devices, and the like.

In a particular implementation consistent with the present invention, a computer readable medium stores instructions executable by a processor for performing a spectral analysis method. When implemented in software or other computer-executable instructions, the elements of the present invention are essentially the code segments to perform the necessary tasks, such as routines, programs, objects, components, data structures, and the like. The program or code segments can be stored in a processor readable medium or transmitted by a computer data signal embodied in a carrier wave over a transmission medium or communication link. The “processor readable medium” may include any medium that can store or transfer information, including volatile, nonvolatile, removable and non-removable media. Examples of the processor readable medium include an electronic circuit, a semiconductor memory device, a ROM, a flash memory, an erasable ROM (EROM), a floppy diskette or other magnetic storage, a CD-ROM/DVD or other optical storage, a hard disk, a fiber optic medium, a radio frequency (RF) link, or any other medium which can be used to store the desired information and which can be accessed. The computer data signal may include any signal that can propagate over a transmission medium such as electronic network channels, optical fibers, air, electromagnetic, RF links, etc. The code segments may be downloaded via computer networks such as the Internet, Intranet, etc. In any case, the present invention should not be construed as limited by such embodiments.

In some embodiments, software implementing the present invention may run directly on a microarray robot. In other embodiments, software implementing the present invention may run on a computing node that is in communication with the microarray robot. In these embodiments, the computing node may be any personal computer (e.g., 286, 386, 486, Pentium, Pentium II, Macintosh computer), Windows-based terminal, Network Computer, wireless device, information appliance, RISC Power PC, X-device, workstation, mini computer, main frame computer or other computing device. The computing node can include a display screen, a keyboard, memory for storing downloaded application programs, a processor, and a mouse. The memory can provide persistent or volatile storage. In other embodiments, the computing node may be provided as a personal digital assistant (PDA), such as the Palm series of PDAs, manufactured by Palm, Inc. of Santa Clara, Calif. In these embodiments, the computing node may communicate with the microarray robot using infrared links.

The data that is processed in the spectral analysis module 100 will be presented with spectral data. The data will generally be acquired using a collecting system (generally within the spectroscopic instrument as discussed below). As used herein, the collecting system will comprise a set of hardware and software components to collect spectroscopic or imaging signals. The hardware components can include any components needed to generate and record the signals from the sample region of interest. The analytical data comprise spectroscopic, imaging, sensor, or scanning data. More preferably, the data further comprise measurements made using laser spectroscopy (e.g., absorption spectroscopy, fluorescence spectroscopy, Raman spectroscopy, and surface-enhanced Raman spectroscopy), luminescence, ultraviolet-visible molecular absorbance, astronomical absorbance, atomic absorbance, infra-red, near infrared, surface plasmon resonance, mass spectrometry, fourier transform spectroscopy, X-ray, nuclear magnetic resonance and other magnetic resonance imaging and spectroscopy, refractometry, interferometry, scattering, inductively coupled plasma, atomic force microscopy, attenuated total reflectance spectroscopy, electron paramagnetic spectroscopy, electron spectroscopy scanning tunneling microscopy, microwave evanescent wave microscopy, near-field scanning optical microscopy, atomic fluorescence, laser-induced breakdown spectroscopy, Auger electron spectroscopy, multiplex or frequency-modulated spectroscopy, X-ray photoelectron spectroscopy, ultrasonic spectroscopy, dielectric spectroscopy, microwave spectroscopy, or resonance-enhanced multiphoton ionization, and the like. Also, combinations of these techniques can be used, for example surface plasmon resonance and fluorescence, Raman and infrared, and any others. Also, different improvements and subclasses of these techniques can be used, for example, resonance Raman, surface-enhanced Raman, resonance surface-enhanced Raman, time-of-flight mass spectrometry, secondary ion mass spectrometry, ion mobility spectrometry, and the like. The techniques used to collect the analytical data may also comprise photon probe microscopy, electron probe microscopy, ion probe microscopy, field probe microscopy, scanning probe microscopy, and the like. In an embodiment, analytical data is provided using techniques relying on collection of electromagnetic radiation in the range from 0.05 Angstroms to 500 millimeters (mm).

The sample may be inorganic material, organic material, polymeric material, biological or chemical material, or combinations thereof. Further, the concentration ranges of species of interest analyzed using these techniques can range from detected single molecules to concentrations of up to 100 percent of materials of interest. Thus, in an embodiment, the sample may comprise a single molecule in a mixture of components. In another embodiment, the parameter of interest may comprise up to 100% of the sample. As described herein, the sample may comprise individual samples, multiple individual samples arranged in a fixed format (e.g., multi-element arrays), as well as a plurality of individual samples (e.g., sample(s) in a mixture). Multi-element arrays may be arranged in a geometrically defined array. Thus, in an embodiment, a sample comprises a combinatorial library. In an embodiment, individual regions in the sample array or library are evaluated separately. In an alternate embodiment, evaluation of the entire array or library is substantially simultaneous.

In some embodiments, spectral data is used as a set of descriptors, for example descriptors of molecular structure. The pattern of the spectrum is determined, for example by segmenting the spectral data into portions covering particular spectral regions (e.g., energy levels, ranges of frequency, wavelength, chemical shift, mass to charge ratio, conditional parameters such as temperature or pressure, and the like). The number and/or the intensity of the spectral signals within each segmented region may serve as the structure descriptors, or may be used as a priori knowledge or a template as described herein below.

The collection and analysis of a spectrum usually involves a source of light or other electromagnetic radiation (an energy source such as a laser, ion source or radiation source) and a device for measuring the change in the energy source after it has interacted with a sample (often a spectrophotometer or interferometer). A spectrum can be used to obtain information about physical, biological or chemical elements, such as atomic and molecular energy levels, molecular geometries, chemical bonds/compositions/structure, interactions of molecules, density, pressure, temperature, magnetic fields, velocity, and related characteristics and processes. Spectral data of a particular type may be utilized in its entirety or in part. Often, spectra are used to identify the components of a sample (qualitative analysis). Spectra may also be used to measure the amount of material in a sample (quantitative analysis). The spectrum is often scaled to the intensity of energy detected, frequency or wavelength, although other scales or measures may be used such as the mass, concentration or dilution, position, or momentum of the energy. While spectral data are often used to elucidate the structure of the components that yields them, the information contained in the spectra may be used in some embodiments without the need to interpret the spectra. Furthermore, the spectral data may be used in certain embodiments without the need to know the structures of the components beforehand. Segmented spectral data is particularly amenable to encryption for secure analysis.

FIG. 1A illustrates an optional embodiment of the present invention in a spectroscopic instrument 200. In this embodiment, the present invention relates to an apparatus or hardware 200 including an electromagnetic radiation source or separator 210, a spectral array detector 220, and a processor 230. The electromagnetic radiation source or separator 210 spatially separates wavelengths representing multiple spectrally distinguishable molecular species. The spectral array detector generates and records the spectroscopic data 240 at a given time and/or spatial resolution. The processor 230 processes the collected data 240 from the spectral array detector and outputs a data matrix 250 which includes separated pure component spectra.

The samples may be analyzed using sensor array techniques. As used herein, a sensor array is a set of sensor elements combined with a single or multiple detectors. Each sensor element can include a material that changes its spectroscopic or other property as a function of analyte concentration in proximity to the element. Using sensor array techniques, a spectroscopically inactive (undetectable) analyte can be detected with a spectroscopic or imaging system that utilizes the method of the invention. In an embodiment, the apparatus of the invention includes at least one energy source for interacting with a sample, an electromagnetic radiation source or separator may be any type of spectral data generators. Preferably, the energy source is a light source, an ion source, or a radiation source. In one embodiment, the light source is a laser or similar light source. In another embodiment, the apparatus of the invention includes no light source for exciting a sample. In this case, detection of thermal or luminescence emission is performed using spectroscopy or imaging. Luminescence emission can include chemoluminescence, bioluminescence, triboluminescence, electroluminescence, and any other type of radiation emission generated by a process that does not involve an absorption of incoming photons and a process that does include absorption of incoming photons.

The data collection system or detector may be an optical spectrometer, an ion spectrometer, a mass detector, an imaging camera, or other instrument capable of quantifying spectral or imaging information. In an embodiment, the detector is an imaging detector, meaning that the detector records the intensity at all locations across a two or three dimensional grid of points. Such detectors include without limitation charge-coupled device (CCD) detectors, complementary metal-oxide semiconductor (CMOs) detectors, charge-injection device (CID) detectors, vidicon detectors, reticon detectors, image intensifier tube detectors, and pixelated photomultiplier tube (PMT) detectors. Those of skill will readily recognize the devices available for measuring the change in the energy source after it has interacted with a sample (often a spectrophotometer or interferometer, e.g., spectrophotometer (e.g., an ultraviolet, visible, or infrared spectrophotometer), a spectropolorimeter, a fluorimeter, an NMR detection instrument, a surface plasmon resonance instrument, or a mass spectroscopy instrument). Some of these detectors have useful features, such as being able to read out only a portion of the image area when this is desired, or providing adjustable spatial resolution by means of binning several pixels together. These are consistent with the invention, and may be incorporated if this is deemed beneficial. Any detector which is an imaging type and has suitable properties such as spatial resolution, sensitivity, and signal-to-noise can be employed, and the choice of one detector over another will be made for the usual engineering reasons such as cost, size, quality, readout speed, and the like.

The processor 230 can comprise the spectral analysis module 100 of the invention. The spectral analysis module is defined as a set of hardware and software components to process the collected analytical data applying the blind source separation or independent component analysis tools to the data in an interactive or iterative maimer. The blind source separation problem considered in the preferred embodiment of the proposed methodology assumes a mixture X of source signals S

X=A S (1)

where A denotes the linear stationary mixing matrix. The ICA or BSS algorithm then determines an un-mixing matrix W such that the mutual information between rows of the recovered source matrix U, with

U=W A S, (2)

is minimized. The source matrix S in this framework results from the calibration and pre-processing of the originally recorded data matrix which depends on the particular spectroscopic application.

The mixture matrix X in a preferred embodiment denotes a two (or more) dimensional spectroscopic data matrix. One axis of the data matrix is defined by the specific spectroscopic data frequency range and the other axis is given by either the spatial or time dimension of the measured spectroscopic quantity. The dimensions will be discussed in detail as pertaining to IR and MRS spectroscopic data.

The class of ICA or BSS algorithms considered encompasses a large variety of approaches based mainly on maximum likelihood estimation and neural network entropy maximization. The latter principles have been shown to be equivalent (J.-F. Cardoso. Infomax and maximum likelihood for source separation. IEEE Letters on Signal Processing, 1997) for the separation of statistically independent source signals. Further analogies have been established to algorithms based on performance measures computing higher-order statistical moments of the separated source statistical distributions (J-F. Cardoso, “High-order contrasts for Independent Component Analysis,” Neural Computation, 1999) on one hand and time delayed decorrelation measures on the other (L. Molgedey and H. G. Schuster. Separation of independent signals using time delayed correlations. Phys. Reviews Letters, 1994). The ICA or BSS approach finally adopted in a specific embodiment needs to be tailored for a particular spectroscopic dataset and may consist of a combination of the general ICA performance measures outlined above while additionally considering a priori constraints on the unmixing solutions. In principle, any ICA or BSS algorithm that relates to minimizing the mutual information among the sensory signals under a priori constraints is considered here and can be readily applied. Since there are many optimization algorithms that achieve the goal of minimum mutual information, systematic and ad-hoc algorithms for solving the minimum mutual information solution under a priori constraints are included in this invention. This methodology extends to constrained nonlinear ICA methods as well. This wide range of algorithms shall be considered as “constrained ICA algorithms”.

There are now many different ICA or BSS techniques or algorithms, including some of the better known algorithms such as JADE (Cardoso & Souloumiac (1993) IEE proceedings-F, 140(6); SOBI (Belouchrani et al. (1997) IEEE transactions on signal processing 45(2)); BLISS (Clarke, I. J. (1998) EUSIPCO 1998)); Fast ICA (Hyvarinen & Oja (1997) Neural Compuation 9:1483-92); and the like. A summary of the most widely used algorithms and techniques can be found in books and references therein about ICA and BSS (e.g Baxter et al., WO 03/073612; Te-Won Lee, Independent Component Analysis: Theory and Applications, Kluwer Academic Publishers, Boston, September 1998, Hyvarinen et al., Independent Component Analysis, 1st edition (Wiley-Interscience, May 2001); Haykin, Simon. Unsupervised Adaptive Filtering, Volume 1: Blind Source Separation. Wiley-Interscience; (Mar. 31, 2000); Haykin, Simon. Unsupervised Adaptive Filtering Volume 2: Blind Deconvolution. Wiley-Interscience (February 2000); Mark Girolami, Self-Organizing Neural Networks: Independent Component Analysis and Blind Source Separation (Perspectives in Neural Computing) (Springer Verlag, September 1999); and Mark Girolami (Editor), Advances in Independent Component Analysis (Perspectives in Neural Computing) (Springer Verlag August 2000). Singular value decomposition algorithms have been disclosed in Adaptive Filter Theory by Simon Haykin (Third Edition, Prentice-Hall (NJ), (1996).

Many popular ICA and BSS algorithms have been developed to optimize their performance, including a number which have evolved by significant modifications of those which only existed a decade ago. For example, the work described in A. J. Bell and T J Sejnowski, Neural Computation 7:1129-1159 (1995), and Bell, A. J. U.S. Pat. No. 5,706,402, is usually not used in its patented form. Instead, in order to optimize its performance, this algorithm has gone through several recharacterizations by a number of different entities. One such change includes the use of the “natural gradient”, described in Amari, Cichocki, Yang (1996). Other popular ICA algorithms include methods that compute higher-order statistics such as cumulants (Cardoso, 1992; Comon, 1994; Hyvaerinen and Oja, 1997). The common characteristic of all ICA algorithms is that they make use of an objective function or contrast function that is related to measuring the mutual information among signals and they use an optimization algorithm to find a linear unmixing system.

### General Approach

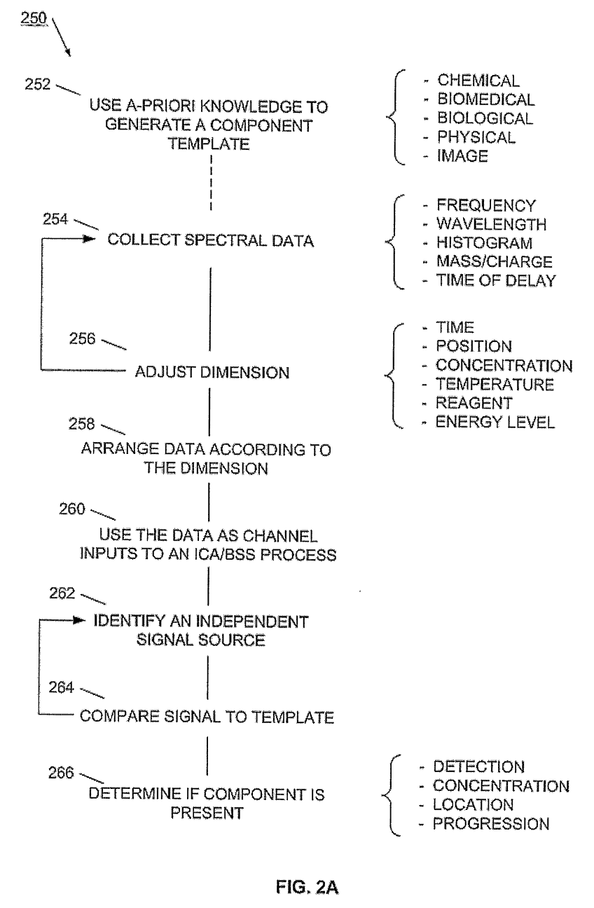

Referring to FIG. 2A, a method for analyzing spectral data is illustrated. Method 250 may be useful for identifying a particular target component of interest, or in determining more specific characteristics of a known target component. The method of the present invention may be used to analyze a parameter of interest in a sample, wherein a parameter of interest comprises a biological, chemical, physical, or mechanical aspect of the sample which can be monitored experimentally. Parameters of interest include, but are not limited to, starting reaction components, chemical intermediates, reaction by-products, final products, structure and composition, function, concentration, and mechanical parameters such as moduli, and the like. Using a-priori information regarding the target component, a target template may be predefined as shown in block 252. This target template may then be used by method 250 in more efficiently identifying or quantifying the desired component. In this regard, if a target template indicates that the target component has a distinguishable spectral response in a particular range, then the method may be focused on collection and analysis in that specific range. In this way, the method concentrates attention on the range of interest, and is able to ignore or minimize the processing of data outside this range.

As shown in block 254, method 250 collects spectral data. The type of spectral data is dependent on the particular target, the environment, and available equipment. It will be appreciated that the type of spectral data collected may be selected according to application specific criteria. The spectral data may be collected using known data collection instrumentation as discussed herein, such as spectrometer, MRI device, or mass spectrometer, for example. Depending on the type of instrument used and the data collected, the data may be arranged in a spectrum according to energy, frequency, wavelength, histogram, mass/charge, time of delay, or other conditional, temporal or special characteristic. It will be appreciated that other spectrum scales may be used depending on the data collected. The spectral data is collected over two or more dimensions, as shown in block 256. A dimension may be, for example: energy (including energy source), time, position, concentration, temperature, and the like, but generally any energy, conditional, temporal or special characteristic. In this way, a first set of data is collected with the dimension set at one value, and then another set of data is collected with the dimension set at another value. In one example, if time is the second dimension, then one set of data is taken at a first time, and a second set of data is taken at a later time. In another example, if temperature is the second dimension, then one set of data is taken at a first temperature, and a second set of data is taken at a different temperature. In yet another example, if energy level or source is the second dimension, then one set of data is taken at one energy level or source and a second set of data is taken at a different energy level or source. The energy source can be from two different spectroscopic devices (similar spectrums or same spectrum) or locations. The collected data is organized and arranged according to the selected dimension, as shown in block 258. It will be understood that more data samples may be taken, and that more than two dimensions may be adjusted.

The arranged data is then used as channel inputs to an independent component analysis (ICA) or blind source separation (BSS) process, as described more fully with reference to FIGS. 1 and 1A (see block 260). The data used by the process may include the entire spectrum of data collected, or a particular range of spectral data may be used. The selected range may be determined according to a priori knowledge of the target, which may be express in the target template. It will be understood that another signal separation process may be substituted. The process generates a set of output signals that represent independent signal sources, as shown in block 262. The template is compared to the independent signals as shown in block 264, and if it matches, then the method 250 determines that the target is present, as shown in block 266. Depending on the type of spectral data and the second dimension, additional information may be extracted regarding the target. For example, if spectral data was collected using time, temperature, or concentration as the second dimension, then concentrations, densities, or levels of the target may be further determined. In another example, if spectral data was collected using position as the second dimension, then location of the target may be further determined. It will be appreciated that by selecting particular types of spectral data, and by selecting appropriate second dimension(s), much information may be determined regarding the desired target.

Referring to FIG. 2B, another method for spectral analysis is illustrated. Method 275 operates on preexisting spectral data. This spectral data may have been collected at an earlier time, or derived from other sources. A dimensional aspect is determined for the spectral data, such as time, temperature, position, or other condition. The spectral data is arranged according to this dimension, as shown in block 277. It will be understood that more data samples may be taken, and that more than two dimensions may be adjusted.

The arranged data is then used as channel inputs to an independent component analysis (ICA) or blind source separation (BSS) process, as described more fully with reference to FIGS. 1 and 1A (see block 279). The data used by the process may include the entire spectrum of data previously collected, or a particular range of spectral data may be used. The selected range may be determined according to a priori knowledge of the target, which may be express in the target template. It will be understood that another signal separation process may be substituted. The process generates a set of output signals that represent independent signal sources, as shown in block 281. The template is compared to the independent signals as shown in block 283, and if it matches, then the method 275 determines that the target is present, as shown in block 285. Depending on the type of spectral data and the second dimension, additional information may be extracted regarding the target. For example, if spectral data has a scale using time, temperature, or concentration as the second dimension, then concentrations, densities, or levels of the target may be further determined. In another example, if spectral data has a scale using position as the second dimension, then location of the target may be further determined. It will be appreciated that by selecting particular types of spectral data, and by selecting appropriate second dimension(s), much information may be determined regarding the desired target.

The present invention also includes systems comprising the method of the invention. The system can be a stand-alone system that performs the analysis of samples directly, or it can be incorporated in a more general system that also includes a separation step. The separation can be performed using any system that analyzes relatively large amounts of materials or a system that analyzes very small amounts of materials (nanogram, femtogram, and less). An example of the latter system can be a lab-on-a-chip system. As another example, a system may comprise a sensor element followed by a separation and detection step.

### IR Example

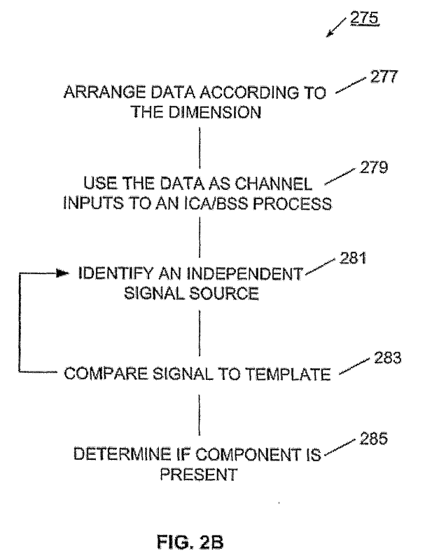

FIG. 3 illustrates an example of using infrared (IR) spectral datasets. In IR spectroscopy, the standard model used to relate the measured absorbance data to the concentration profiles of absorbing species and their pure component spectra is the Beer-Lambert law (or Beer's law). The general Beer-Lambert law is usually written as:

A(t,λ)=b*C(t)*E(λ) (3)

where A is the measured absorbance at time t and wavelength λ, E(λ) is a wavelength-dependent absorptivity coefficient (pure component spectrum), b is the path length and C(t) the concentration profile in time. A, E and C are positive matrices. Experimental measurements are usually made in terms of transmittance (T), which is defined as:

T=I/Iₒ

where I is the light intensity after it passes through the sample and Iₒ is the initial light intensity. The relation between A and T is:

A=−log T=−log(I/Iₒ).

The problem of identifying C and E from A becomes especially challenging when no a priori knowledge about the number of components, the concentration profiles nor the pure components absorption spectra is available. A number of methods have been suggested in spectroscopic applications to provide solutions to this problem. In NMR spectroscopy for example, applications have been reported focusing on Principal Component Analysis (PCA) (Stoyanova, Kuesel, Brown, Application of Principal Component Analysis for NMR Spectral Quantitation, Journal of Magnetic Resonance, 1995) whose solutions are subsequently transformed into positive basis vectors. Other methods minimize the posterior probability of C and E given A (Ochs, Stoyanova, Arias-Mendoza, Brown, A New Method for Spectral Decomposition using a Bilinear Bayesian Approach, Journal of Magnetic Resonance, 1999) or the likelihood of B given C and E (Sajda, Du, Brown, Parra, Stoyanova, Recovery of Constituent Spectra in 3D Chemical Shift Imaging using Non-Negative Matrix Factorization, Proceedings of ICA 2003, 2003) subject to positivity constraints and suitable prior knowledge about C and E.

In the proposed embodiment, an absorbance matrix A(t,λ) is recorded on a particular reaction system over a certain time and frequency range. Since the time dimension is assumed larger than the number of reaction species, the absorbance matrix is first subject to a PCA dimension reduction step, yielding A^{r}. The number of reaction species can be estimated with factor or rank analysis of A. The reduced absorbance matrix is then fed to the ICA module which computes an un-mixing matrix W such that

U=W*A^{r} (4)

subject to the positivity constraints

U>0 (5)

U is the matrix of separated pure component spectra. The corresponding indicative concentration profiles in time can be obtained by

P(t)=A*pinv(U) (6)

If desired, the true concentration profiles C(t) can be determined from P(t) from

C(t)=L*P(t) (7)

where L is a diagonal matrix with positive coefficients.

FIG. 3 shows a simulation example 300 of mixture and separated absorbance spectra. It can be seen that the spectra recovered with the proposed embodiment correspond to the original pure component spectra and the corresponding concentration profiles match the evolution of the simulated reaction system.

MRS Example

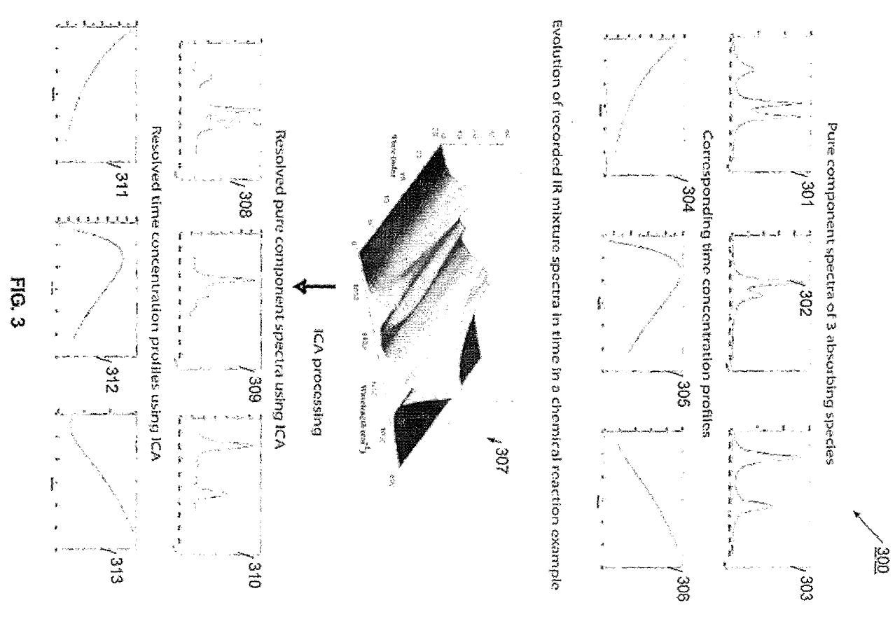

In another application of the spectral analysis, an MRS scan is taken of a patient's brain. Due to the size and complexity of the scan, the scan is divided into areas, or voxels. To assure complete coverage, the voxels typically overlap, and may include areas outside the brain. For example, voxels near the edge of the scan may include scalp, skull, and other tissue structures. Each voxel is converted to a set of spectral data, typically using frequency or wavelength as the spectral scale. Since each voxel represents a different spatial position in the patient's brain, position is used as the second dimension. More particularly, the MRS data matrix may consist of the MRS of 256 (16×16) voxels from a patient with a tumor near the center of the field of view. In other words, one axis of the data matrix is defined by the specific spectroscopic data at different frequency and the other axis is given by the spatial dimension of the measured spectroscopic quantity. The outputs of ICA consist of spectrally independent components which fixed spatial distributions. The panel 325 shown in FIG. 4 shows MRS spectral data 327 of all 256 voxels (zero-frequency is shifted to the center of the spectrum). As shown in FIG. 4, each data set is dominated by a center peak 329, which masks the presence of peaks indicative of a tumor. Since human tissue is dominated by water, it is likely that the dominant peak represents the spectral response for water. In MRS, the recorded resonance data matrix usually has one frequency dimension (resonance spectra) and one or two spatial dimensions (2D or 3D). Without loss of generality, only 2 dimensional resonance datasets are discussed here.

The situation of resonance spectra recorded over a certain number of voxels is considered. In a first approximation (discarding nonlinear effects such as magnetic field inhomogeneities or signal cancellation of overlapping resonances due to phase differences in spin echo sequences), one can assume a linear relationship between the number of resonating nuclei and the recorded total resonance radiation

R(1,λ)=D(1)*E(λ) (8)

where R is the mixed resonance spectrum matrix for voxels 1 and wavelengths λ,
D the component concentration matrix for voxels 1 and E the pure component resonance spectrum matrix as a function of wavelength λ.

Statistically speaking, the recorded MRS spectra have sparse, Laplacian distributions and therefore fulfill one of the basic assumptions of signals separable by ICA algorithms. After suitable pre-processing and calibration of R, an ICA un-mixing matrix W is computed yielding the separated independent component resonance spectra IC with

IC=W*R (9)

subject to the positivity constraints

IC>0 (10)

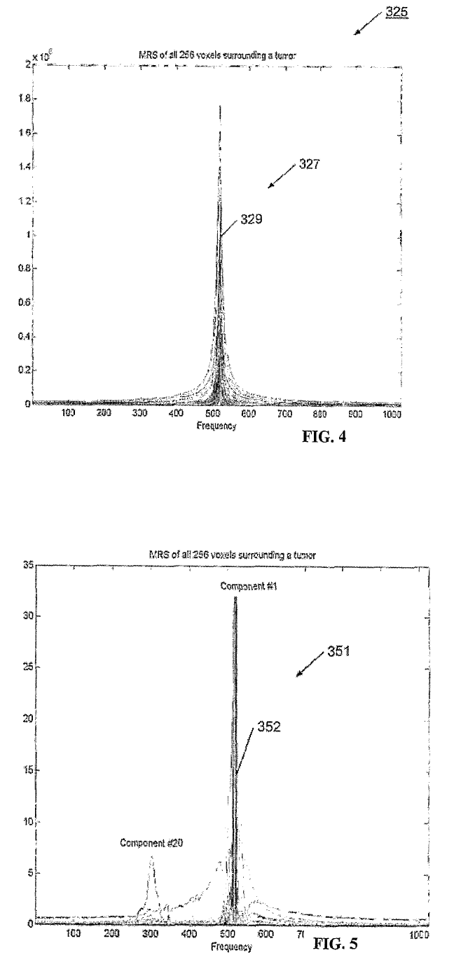

As shown in FIG. 5, the raw MRS spectral data is resolved into independent component signals 351. Each of these signals represents an independent signal source. These resolved spectra can then be matched against a database or interpreted by the experimenter. For example, since water is known to dominate human tissue, it is very likely that component #1 352 is indicative of water. Since the un-mixing matrix W is the inverse of D(1), it contains information about the spatial distribution of the identified independent components. Therefore, by taking its inverse, the spatial areas where the separated component spectra specifically originate from can be identified. If a priori information about the number of components to be identified is available, a PCA dimension reduction of the resonance matrix can be computed before the blind source separation step.

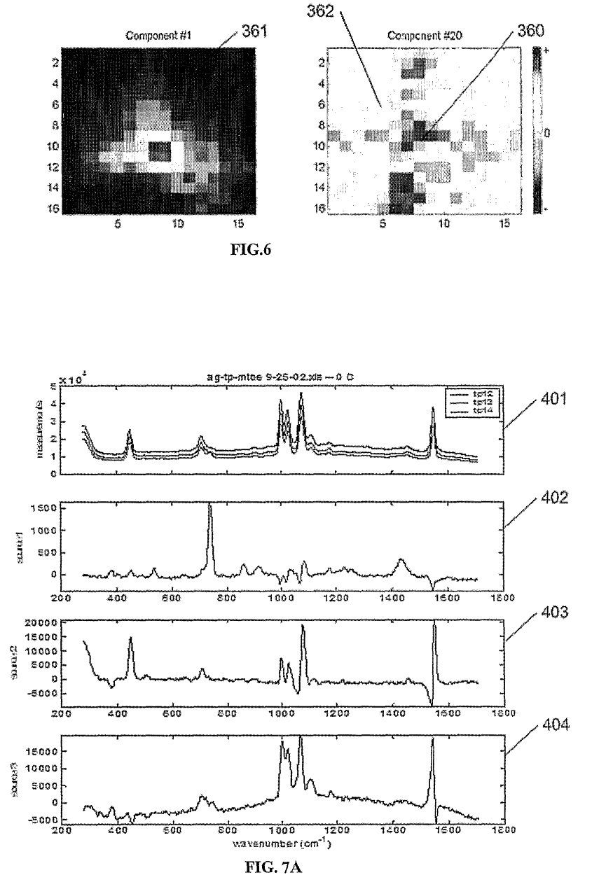

FIG. 4 gives an example of a recorded mixture MRS spectrum and FIG. 5 shows the corresponding resolved independent component spectra. FIG. 6 shows the spatial locations in which those spectra show predominant activations. In this way, the ICA process reveals and enables identification of small signals that are indicative of a tumor 360. Also, since a benign tumor may have a different spectral template than a more aggressive tumor, it is also possible that the type of tumor can be identified using the resulting independent components. And, since the second dimension is position, the process also enables precisely locating the tumor. For example, FIG. 6 shows the contributions of components number 1 361 and components number 20 362 in a cross section of the brain. Component #1 361 mainly accounts for water, while component #20 362 may account for the spectra of the membrane of cells which are missing inside the tumor 360. Using these and other component signals, the likely position of the tumor may be accurately identified. It is possible that the ICA process may identify other component signals indicative of cells that are prone to tumor influence. In this way, the resulting component spectra may show a likely path of tumor progression. Using this information, radiation treatments or surgery may be adjusted to remove cells that are both tumorous and likely to become tumorous, increasing the likelihood of patient survivability.

While a linear mixing model (1) has been put forward in a first approximation, the ICA separation processing step can be extended to mildly non-linear source mixing situations. As noted earlier for the case of IR data, the experimenter has to determine a concentration, pressure and temperature range in which the Lambert Beer law is valid. In the case of MR data, magnetic field inhomogeneities or conflicting resonance effects may for example cause local nonlinear effects undermining the linear assumptions made in (8). Therefore the ICA mixing model should consider further constraints such as

Cₘᵢₙ(t)<C(t)<Cₘₐₓ(t) for model (3) (11)

Dₘᵢₙ(1)<D(1)<Dₘₐₓ(1) for model (8) (12)

and also a priori assumptions about the pure component spectra, if available, defined as

Eₘᵢₙ(1)<E(1)<Eₘₐₓ(1). (13)

Furthermore ICA algorithms can be considered in an embodiment that explicitly takes into account nonlinear mixing situations such as

A(t,λ)=f(b*C(t)*E(λ)) in analogy to model (3) (14)

R(1,λ)=f(D(1)*E(λ)) in analogy to model (8), (15)

with suitable constraints (11)-(13), where the function f describes the nonlinear behavior observed for a particular recording dataset. Nonlinear ICA algorithms maximizing statistical independence of separated pure component spectra mixed by (14) and (15) invoking maximum likelihood, entropy maximization or time (or space) delay decorrelation principles are therefore explicitly named as potential ICA processing embodiments.

It should be apparent from the disclosure provided herein that the maimer in which the chemical data are generated is irrelevant to the use of the process of the invention for analysis of the data. That is, the skilled artisan in the field of chemical analysis may, without effort, generate the necessary data, or choose the necessary data from an available source for analysis in the present process. Thus, the invention should in no way be construed to be limited to the manner in which any chemical data are acquired, but rather should be construed to include the analysis of any chemical data, irrespective of the mechanism used for the acquisition thereof. For example, the signal separation and post-processing of 2D MRS signals could be equally effective for other spectral signals such as 2-Dimensional IR spectroscopy (Spatial x IR spectroscopy) and 2-Dimentional Neutron scattering images.

The separated pure component spectra are further subject to post processing such as rotation or calibration of separated time and spatial profiles by taking into account a priori knowledge about a particular spectroscopic dataset. In the case of IR data for example, the exact concentration values rather than only their time course can be determined by using mass balances or concentration measurements obtained by a different method. After ad hoc post processing of separated component data has been performed, automatic interpretation and classification routines are used to match the resulting data against a previously trained database. These classification methods can range from simple pattern recognition techniques such as discriminant functions to advanced tools like Neural Network (Haykin, S “Neural Networks: A Comprehensive Foundation”. 1998) or Support Vector Machines (Vapnik, V. Statistical Learning Theory. 1998) or Bayesian Networks and Graphical Models (F. V. Jensen. “Bayesian Networks and Decision Graphs” 2001, M. I. Jordan. “Learning in Graphical Models”. 1998). Depending on the individual scores or combination of scores obtained with each classification tool, a robust component detection or tracking system is designed to provide the experimenter with additional analytical information to interpret high dimensional spectroscopic data. In the case where no match is found in a database, the separated component spectra may contain information about new phenomena and thus provide support for further explorative purposes.

SERS Example with Time as the Second Dimension

Another application includes enhanced Raman spectroscopy (SERS). Raman spectroscopy is a class of vibronic spectroscopies in which photons are scattered inelastically from molecules of interest. This results in a change of frequency of the scattered photons from that of the incident photons. SERS is a modification to the Raman spectroscopy where it has been found, that on some selected metal surfaces, the Raman cross-section for the molecules is enlarged by many orders of magnitude, resulting in a strong enhanced signal. SERS is an attractive technique to detect and identify contaminants of environmental concern. Measurement of SERS consists of a spectrum of shifts in frequency of the scattered photons.

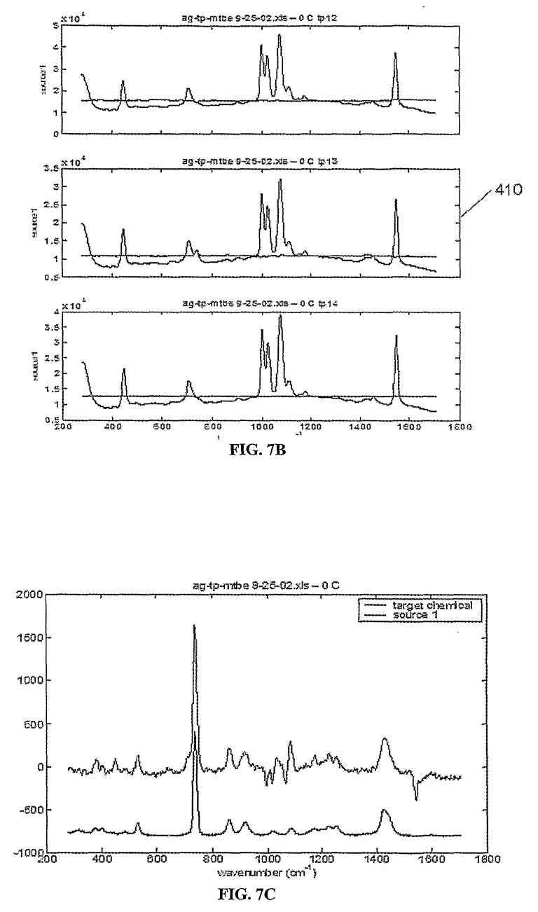

In a more specific example illustrated in FIGS. 7A, 7B, and 7C, spectra of methyl t-butyl ether (MTBE) were recorded at a fixed SERS substrate temperature over time. In this way, the second dimension is temporal. In FIG. 7A, three time-spaced recorded spectra of MTBE from SERS at 0° C. are shown in the upper row 401. The spectra are dominated by the Raman scattering of the substrate. The spectra data was used as channel inputs to an ICA process, which generated a set of independent signal sources. Rows 2 (402), 3(403), and 4(404) show three of the separated spectra signals. Since the spectral response of MTBE is well know, it may act as a target template. The target template for MTBE is compared to the separated signals, and the signal with the best fit is identified. Among the three separated spectra, the one that most resembles a VOC is identified as “source 1” 402.

The contribution of this plausible VOC spectrum 402 is estimated by inverting the signal separation process. A weighted mixing of extracted VOC spectrum and extracted baseline spectra in 403 and 404 is created. The weights are adjusted to give best fit of the created signal to the original recorded spectra in 401. The corresponding weight of the VOC spectrum then reflects the contribution of the VOC spectrum. This contribution is drawn together with the original datasets as shown in FIG. 7B. It is verified that the VOC spectrum is most prominent in recorded spectrum “tp13” 410, but still contributes for less than 1% of the amplitude in the recorded spectrum. However, even at these minute levels, the MTBE has been confidently detected. It will be appreciated that many factors influence the level of MTBE in these time-spaced datasets. Accordingly, greater confidence in detection and quantification may be achieved by using several datasets.

The extracted VOC spectrum is shown being compared to the known Raman spectrum of MTBE in FIG. 7C. Peaks at 533.6, 737.6, 859.9, 921.8 and 1432.7 cm⁻¹ are readily identified, as well as peaks at 396.6, 403 and around 1200 cm⁻¹. Accordingly, the identification has been made confidently. Unfortunately, in this dataset, the concentration of MTBE is not specified.

SERS Example with Temperature as the Second Dimension

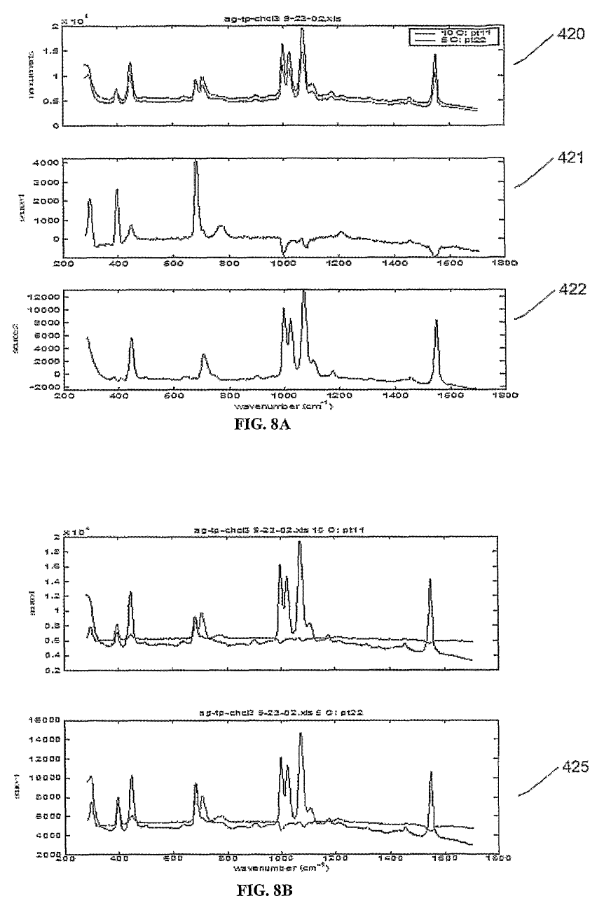

Another application of SERS uses one or more volatile organic compounds (VOC) to identify a target component. The top panel 420 of FIG. 8A shows two SERS recordings of CHCl₃ at different surface temperature. In this way, temperature is used as the second dimension. The spectra are dominated by the Raman scattering of the surface substrate. The spectra data was used as channel inputs to an ICA process, which generated a set of independent signal sources. The second 421 and third 422 panels show the separated signal spectra using ICA, of which the one that resembles a VOC spectrum most is identified. Since the spectral response of CHCl₃ is well know, it may act as a target template. The target template for CHCl₃ is compared to the separated signals, and the signal with the best fit is identified. Among the two separated spectra, the one that most resembles a VOC is identified as “source 1” 421.

The contribution of this plausible VOC spectrum 421 in the original two raw recordings is then computed and shown in FIG. 8B. It is verified that the VOC spectrum is most prominent in recorded spectrum “pt22” 4425, but still contributes only a small amplitude in the recorded spectrum. However, even at these minute levels, the CHCl₃ has been confidently detected. It will be appreciated that many factors influence the level of CHCl₃ in these temperature-spaced datasets. Accordingly, greater confidence in detection and quantification may be achieved by using several datasets. It can be seen that this spectrum explains the correlations among related peaks in the raw data.

The extracted VOC spectrum in FIG. 8C is also compared to regular Raman spectrum of clean CHCl₃. Peaks at 295.3, 394.4 and 681.3 cm⁻¹ are readily identified, as well as peaks at 773.4 and 1213.4 cm⁻¹. Accordingly, the identification has been made confidently

### Chemical or Biological Threat Example

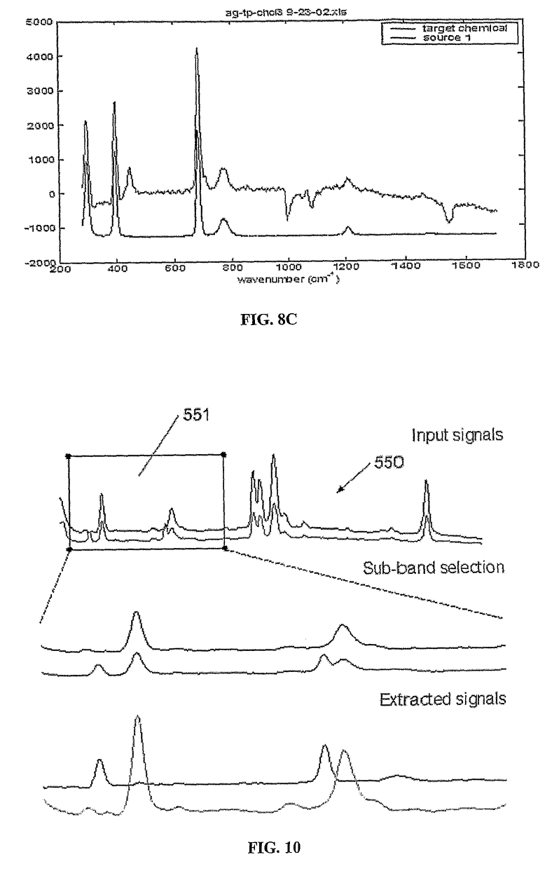

Referring to FIG. 9, a threat detection system is illustrated. The threat detection system may be useful for identifying explosive, nuclear, biological, or chemical compounds, even when hidden and when in small quantities. The threat detection system may be employed in a portable device, for example in a hand-held or towable device, or may be more permanently installed. Such permanent installations may include luggage scanners, truck scanners, freight scanners, and passageway detectors. It will be appreciated that the threat detector may be sized and equipped according to the specific application and threat component.

However structured, the threat detector generally has a scanner for detecting spectral data. For example, FIG. 9 shows threat detector as a luggage detector 500. Luggage detector 500 may be, for example, permanently installed at an airport facility for effectively scanning passenger luggage for threats. A piece of luggage 501 is placed in the luggage detector 500, where it is scanned using one or more know scanning techniques. For example, the luggage may be scanned with X-ray, gamma ray, or other know scanning processes. The luggage may contain may items, and if a hidden threat, such as an explosive 505 is hidden in the luggage, it is likely that the perpetrator has tried to mask the presence of the explosive with other compounds. For example, the perpetrator may place perfume 502, chocolate 503, and coffee 504 adjacent to the explosive. Further, the explosive may be shielded by one or more other compounds or structures. With such a complex array of compounds, the presence of the explosive may be buried or hidden in a resulting scan signal 510. Even though the explosive has a known spectral template 512, the other compounds have effectively masked the presence of the explosive.

In operation, the luggage detector 500 takes at least two spectral datasets using the scanner, with each scan having a different second dimension value. For example, there may be a time difference between the first and second scans, or the scans may be taken from different positions. In another example, the intensity or frequency of the scan may be adjusted as the second dimension. It will be understood that more than two scans may be taken, and that more than one dimension may be adjusted between scans. The datasets are used as an input to a signal separation process, such as an ICA process discussed with reference to FIGS. 1 and 1A. The signal separation process separates the aggregate signal 515 into a set of independent signals 520. These independent signals 520 are compared to known threat templates, such as template 512, to identify a threat signal. Here, independent signal 521 matches the threat template 512, so the presence of an explosive device has been confirmed. It will be appreciated that, depending on the type of scan and the type of second dimension, that other information may be derived about the threat. For example, the quantity of the component or the location of the component may be more accurately identified.

### General Extensions

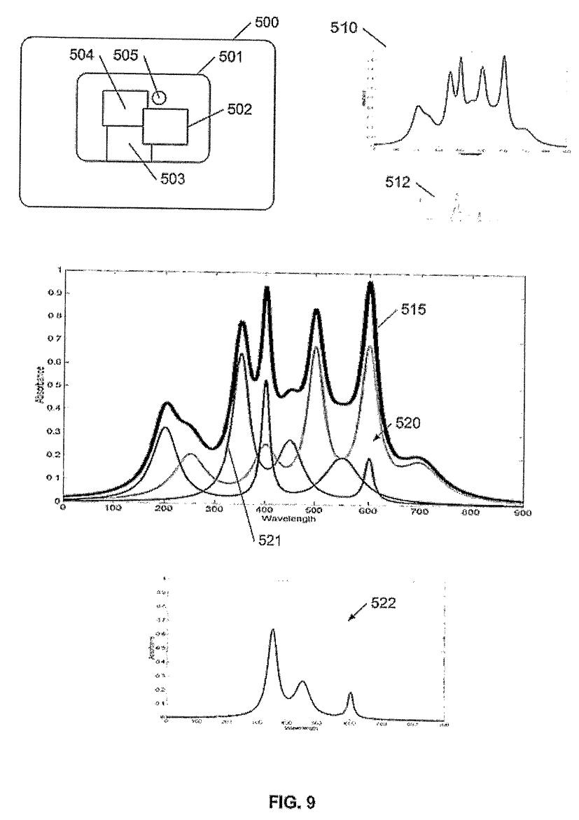

In many real-life situations, the process of spectra mixing may drift slowly as we move along the frequency/wavenumber axis. Referring now to FIG. 10, it is illustrated that spectral separation can be applied to the entire recorded spectra 550 without any a priori knowledge or can be applied to selected bands 551, based on some knowledge of the spectral bands of interest for different targets. For example, assume a non-stationary overlapping process in which the overlapping interaction varies with the wave number. If we know the sub-bands of interest of the targets are just a portion of the data (in the box). ICA can be applied to the spectra within the window 551. The ‘component’ spectra obtained by ICA or BSS will be statistically independent from each other within the box. Note that the bands of interest are not necessarily contiguous. They could comprise one or multiple sub-bands of the full spectrum.

To produce multiple raw spectra datasets, one can repeat the recording process under different recording conditions. These changes, for example, may be different temperatures (e.g., of the SERS substrates), amount of time allowed or different recording lengths (e.g., for the condensation of the VOC onto the substrate), frequency of the exciting laser, or using different substrates, different spectra, chromatograms, ionograms or sensor array data, and the like. It will be appreciated that other factors may be used as a second dimension as discussed above. More preferably, a plurality of, e.g., at least 5, 10, 20, 50, 100, 200, or more, measurements of a parameter or parameters, e.g., a thermodynamic, spectroscopic, chromatographic, or biological parameter, are determined simultaneously, e.g., by using high throughput screening techniques (e.g., involving multi-cell or multi-channel instruments, or multi-cell or multi-channel calorimeters), spectrophotometers, spectropolorimeters, fluorimeters, NMR detection instruments, mass spectroscopy, column chromatography instruments, diffusion barrier instruments, solubility instruments, capillary based techniques, microarrays, automated visual imaging devices, and the like.

In example of another second dimension, the ICA or BSS process can be applied with only one measured spectrum from the target. The spectrum of the background can be measured in advance without the presence of the target agents or chemicals and stored. When a new measurement is performed, the obtained spectrum can be fed to the process together with the stored background spectrum. To produce even more reliable estimation, the spectra of the background and of the unknown material can be repeatedly measured. The background spectra will be subtracted automatically and intelligently.

The contribution of the extract sources to the original measured spectra can be computed by inverting the extracting procedure. In general, the contribution of each extracted spectrum to each raw measurement is estimated such that when they are pulled together, give the original data.

In some applications, it will be appreciated that the identity and number of the underlying pure spectra are unknown. It will be understood that the number of underlying spectra present can be estimated by increasing the number of raw spectra used incrementally, until the extracted spectra do not indicate any new plausible spectrum. To identify which of the extracted spectra are from the background, one can perform correlation analysis between the extracted spectra and that of the background. To identify which of the extracted spectra are from plausible suspicious chemicals, statistics may be computed regarding the spectra such as skewness, sparseness and kurtosis. It will also be understood that the noise in extracted spectra can be cleaned by low-pass filtering or windowed smoothing.

As spectral data usually consists of intensity or counts over a range of frequency or wavelength, the spectrum will have non-negative values in intensity or counts. For those spectral data this condition applies, enforcing non-negative constrain on the extracted spectrum will reduce the search space of the model parameters, speed up the learning process and eliminate artifacts in the extracted spectra such as negative intensity or counts.

The spectra mixing process will usually result in an accumulation of measured spectral intensity but no degradation of intensity. Putting non-negative constrain on the model parameters for the spectrum overlapping process such as C(t) in equation (3) or D(1) in equation (8) will reduce the search space and speed up the learning process.

During the process of spectra mixing in a real-life system, peaks of the pure underling spectra may be shifted. The technology may be modified to model convolution and frequency shifting in the overlapping process. Equation (3) will be modified as:

A(t,λ)=b₀*C₀(t)*E(λ)+b₁*C₁(t)*E(λ+Δλ)+b₂*C₂(t)*E(λ+2Δλ)+ . . . +b₋₁*C₋₁(t)*E(λ−Δλ)+b₋₂*C₋₂(t)*E(λ−2Δλ)+ (16)

Finally, we may exploit the statistical properties of expected underlying spectra, over-complete model can be employed which may extract more spectra then the number of input spectra.

Upon separation of the individual components, this component information can be further analyzed using known post-processing procedures, for example to adjust the signal to noise ratio, or sampled or compared with existing information sources, e.g., databases, scientific publications, or internet webpages, or other predicted values, e.g., thermodynamic, spectroscopic, chromatographic, or biological values. This can be done visually by those skilled in the art with such knowledge or automated by processes known in the art. A data analysis tool can be applied that compares measured data from a sample (e.g. the signal quality response function value) to a pre-determined standard (e.g. a pre-determined signal quality response function value).

Certain aspects, advantages and novel features of the invention have been described herein. Of course, it is to be understood that not necessarily all such aspects, advantages or features will be embodied in any particular embodiment of the invention. The embodiments discussed herein are provided as examples of the invention and are subject to additions, alterations and adjustments. Therefore the scope of the invention is defined by the following claims.

### REFERENCES

Amari, S., Cichocki, A., Yang, H., A New Learning Algorithm for Blind Signal Separation, In: Advances in Neural Information Processing Systems 8, Editors D. Touretzky, M. Mozer, and M. Hasselmo, pp. 757-763, MIT Press, Cambridge Mass., 1996.

Bell A J and Sejnowski T J. An information-maximization approach to blind separation and blind deconvolution. Neural Comput 7:1129-59, 1995.

Cardoso J.-F., Iterative techniques for blind source separation using only fourth order cumulants In Proc. EUSIPCO, pages 739-742, 1992.

Cardoso, J.-F., Infomax and maximum likelihood for source separation. IEEE Letters on Signal Processing, 4:112-114, 1997.

Cardoso, J.-F., High-order contrasts for independent component analysis, Neural Computation, 11(1): pp 157-192, 1999.

Comon, P., Independent component analysis, a new concept? Signal Processing, 36(3):287-314, April 1994.

Haykin, S, Neural Networks: A Comprehensive Foundation, Prentice Hall, 1998.

Hyvaerinen, A. and Oja, E, A fast fixed-point algorithm for independent component analysis. Neural Computation, 9, pp. 1483-1492, 1997

Hyvarinen, A. Karhunen, J., E. Oja, E. Independent Component Analysis, John Wiley & Sons, 2001.

Gauglitz and Vo-Dinh, Handbook of Spectroscopy, Wiley-VCH; (October 2003).

Jansson, P. A., Deconvolution of Images and Spectra Academic Press; 1st edition (Jan. 15, 1997).

Jensen, F., Bayesian Networks and Decision graphs, Springer-Verlag, New York, 2001

Jordan, M., (ed) Learning in Graphical Models, MIT Press, 1998

Jung T-P, Makeig S, McKeown M. J., Bell, A. J. , Lee T-W, and Sejnowski T J, Imaging Brain Dynamics Using Independent Component Analysis , Proceedings of the IEEE, 89(7):1107-22, 2001.

Te-Won Lee, Independent Component Analysis: Theory and Applications, Kluwer Academic Publishers, Boston, Mass., 1998.

Liang, Y.-Z.; Kvalheim, O. M.; Manne, R. M., White, grey and black—A classification of methods for quantitative analysis of multicomponent analytical systems. Chemometrics and intelligent laboratory systems. 18, s. 235-250 1993

Liang, K.-P., Boada, F., Constable, R., Haacke, E., Lauterbur, P., Smith, M., Constrained reconstruction methods in MR imaging. Rev. Magn. Reson. Med. 4, 67-185 (1992).

Matson, G. B. and Weiner, M. W.: Spectroscopy. Chapter in Magnetic Resonance Imaging. Third Edition. Editors: D. D. Stark and W. G. Bradley, Jr., Mosby-Year Book, St. Louis, Mo. (In press).

Mason G. F., Pan J. W., Ponder S. L., Twieg D. B., Pohost G. M., Hetherington H. P. Detection of brain glutamate and glutamine in spectroscopic images at 4.1T. Magn. Reson. Med. 32, 142-145 (1994).

Miller, T. J. Schaewe, C. S. Bosch, J. J. H. Ackerman. Model based maximum-likelihood estimation for phase and frequency encoded magnetic resonance imaging data. J. Magn. Reson. B107, 210-221 (1995).

Molgedey, L., Schuster, H., Separation of a Mixture of Independent Signals Using Time Delayed Correlations, Physical Review Letters, Vol. 72, No. 23, pp. 3634-3637, 1994.

Ochs, M. F., Stoyanova, R. S., Arias-Mendoza, F., Brown, T. R., A New Method for Spectral Decomposition using a Bilinear Bayesian Approach, Journal of Magnetic Resonance, vol. 137, pp. 161-176, 1999.

Plevritis S. K., Macovski A. MRS imaging using anatomically based k-space sampling and extrapolation. Magn. Reson. Med. 34, 686-693 (1995).

Sajda, P., Du, S., Brown, T., Parra, L., Stoyanova, R., Recovery of Constituent Spectra in 3D Chemical Shift Imaging using Non-Negative Matrix Factorization, Proceedings of ICA 2003, pp. 71-76, Nara, Japan, 2003.

Sasaki, K., Kawata, S., Minami, S., Estimation of Component Spectral Curves From Unknown Mixture Spectra, Applied Optics, 23, No 12, 1984.

Stoyanova, R., Kuesel, A. C., Brown, T. R., Application of Principal Component Analysis for NMR Spectral Quantitation, Journal of Magnetic Resonance A, 115, pp. 265-269, 1995.

Vapnik, V. N., Statistical Learning Theory. Wiley, 1998

What is claimed is:

1. A method for analyzing spectral information, comprising:
arranging spectral data according to a second dimension;
using the arranged data as input channels to a signal separation process; and
identifying, responsive to the signal separation process, an independent signal source.

2. The method according to claim 1, further including the step of collecting the spectral data.

3. The method according to claim 2, where the collecting step comprises using a spectroscopic instrument.

4. The method according to claim 2, where the collecting step comprises using a mass spectrometer.

5. The method according to claim 1, further comprising the step of using a-priori knowledge of the independent signal source to adjust the signal separation process.

6. The method according to claim 1, further including the step of using a-priori knowledge of the independent signal source to generate a component template, and wherein the identifying step further includes comparing the component template to one or more signals separated by the signal separation process.

7. The method according to claim 1, wherein the signal separation process further comprises an ICA (independent component analysis) process.

8. The method according to claim 1, wherein the second dimension is time, position, concentration, temperature, or energy level.

9. The method according to claim 1, where the spectral data has a scale of frequency, wavelength, number of hits, mass/charge, or time of delay.

10. A method for identifying a target component, comprising:
collecting a first spectral dataset;
changing a dimension;
collecting a second spectral dataset at the changed dimension;
using the first and second datasets as inputs to a signal separation process;
generating, using the signal separation process, an independent signal; and
identifying the independent signal as being indicative of the target component.

11. The method according to claim 10, further comprising using a-priori knowledge regarding the target component to generate a component template, and wherein the identifying step comprises comparing the component template to the independent signal.

12. The method according to claim 10, where the collecting steps comprise collecting infrared (IR) spectral data.

13. The method according to claim 10, where the collecting steps comprise collecting MRS spectral data.

14. The method according to claim 10, where the collecting steps comprise collecting SERS spectral data.

15. The method according to claim 10, wherein the changing step comprises changing time between collecting the first spectral dataset and collecting the second spectral dataset.

16. The method according to claim 10, wherein the changing step comprises changing position between collecting the first spectral dataset and collecting the second spectral dataset.

17. The method according to claim 10, wherein the changing step comprises changing temperature between collecting the first spectral dataset and collecting the second spectral dataset.

14. The method according to claim 10, where the target component is a chemical compound.

15. The method according to claim 10, where the target component is a biomedical tissue.

16. The method according to claim 10, where the target component is a biological cell or molecule.

17. The method according to claim 10, where the target component is a feature of a graphical image.

18. The method according to claim 10, where the target component is a physical feature of a structure.

19. The method according to claim 10, wherein the signal separation process farther comprises an ICA (independent component analysis) process.

20. A device for detecting a target component, comprising:
a spectrometer; and
a processor performing the steps of:
receiving a first spectral dataset from the spectrometer;
receiving a second spectral dataset from the spectrometer;
arranging the received datasets according to a second dimension;
using the first and second datasets as inputs to a signal separation process;
generating, using the signal separation process, an independent signal; and
identifying the independent signal as being indicative of the target component.

21. The device according to claim 20, wherein the spectrometer further comprises an electromagnetic radiation separator.

22. The device according to claim 20, wherein the spectrometer further comprises a spectral array detector.

23. A system and method for blind source separation of multi-dimensional recorded spectroscopic data where the separation is achieved through the use of an ICA algorithm based on an instantaneous linear mixture model subject to positivity constraints on the resolved independent components.

24. The system of claim 23 where the spectroscopic data matrix comprises Infra-Red spectroscopy absorbance measurements.

25. The system of claim 24 where the spectroscopic data matrix is calibrated and pre-processed including PCA dimension reduction before being post-processed by an ICA algorithm; where the concentration profile of identified independent components is determined using the original recorded spectroscopic data matrix and un-mixing matrix determined by the ICA algorithm.

26. The system of claim 23 where the spectroscopic data matrix comprises Magnetic Resonance spectra from spatial (2D or 3D) measurements.

27. The system of claim 26 where the spectroscopic data matrix is calibrated and pre-processed including PCA dimension reduction before being post-processed by an ICA algorithm; where spatial localization of resolved independent resonance spectra is inferred from the un-mixing matrix computed by the ICA algorithm.

28. A analytic toolbox for analyzing spectral information, comprising:
arranging spectral data according to a second dimension;
using the arranged data as input channels to a signal separation process; and
identifying, responsive to the signal separation process, an independent signal source.
